(19) United States
(12) Patent Application Publication
(10) Pub. No.: US 2024/0169088 A1
(43) Pub. Date: May 23, 2024

(54) SYSTEMS AND METHODS FOR PROVIDING SEARCHABLE ACCESS TO DOCUMENTS ACROSS SEPARATE DOCUMENT REPOSITORIES

(71) Applicant: BP Corporation North America Inc., Houston, TX (US)

(72) Inventor: Pramod NEELAPPA, Fulshear, TX (US)

(73) Assignee: BP Corporation North America Inc., Houston, TX (US)

(21) Appl. No.: 18/508,455

(22) Filed: Nov. 14, 2023

Related U.S. Application Data
(60) Provisional application No. 63/425,113, filed on Nov. 14, 2022.

(51) Int. Cl. G06F 21/62

(52) U.S. Cl. CPC G06F 21/6227; G06F 21/6245

(57) ABSTRACT

A computer implemented method for providing access to documents across a plurality of separate document repositories includes: providing an index containing a plurality of documents sourced from a plurality of separate document repositories; providing a search result to a user in response to a search query, the search result referencing one or more documents sourced from the plurality of document repositories; extracting content from a plurality of documents sourced from the plurality of document repositories and constructing a data visualization based on one or more user prompts, where, the data visualization includes tabular or graphical data contained in the documents referenced in the search result; and extracting metadata from the documents referenced in the search result. Additionally, the method includes automatically detecting the presence of sensitive information in the extracted content, and allowing the user to select and download the one or more documents referenced by the search result.

### CROSS-REFERENCE TO RELATED APPLICATIONS

This application claims benefit of U.S. provisional patent application Ser. No. 63/425,113 filed Nov. 14, 2022, and entitled “Method and Apparatus for Implementing Searching Across Remediation Applications and Other Document Repositories,” which is hereby incorporated herein by reference in its entirety for all purposes.

### STATEMENT REGARDING FEDERALLY SPONSORED RESEARCH OR DEVELOPMENT

Not applicable.

### BACKGROUND

In today's digital age, the management and retrieval of documents and data spread across different repositories have become a critical concern. Conventional search engines or tools, often adapted to the cloud environment in enterprise-oriented applications, play a central role in addressing this challenge. These search engines are designed to index, query, and retrieve documents across diverse data sources, including file systems, databases, content management systems, and contemporary cloud storage services such as Amazon Web Services (AWS) CloudSearch and Azure® Cognitive Search.

### BRIEF SUMMARY OF THE DISCLOSURE

An embodiment of a computer implemented method for providing access to documents across a plurality of separate document repositories comprises (a) providing an index containing a plurality of documents sourced from a plurality of separate document repositories, (b) extracting content from a new document in response to the uploading of a new document to one of the plurality of document repositories, (c) automatically detecting the presence of sensitive information in the extracted content of the new document, and (d) updating the index to flag the presence of sensitive information in the content of the new document following (c). In some embodiments, the method comprises (e) deleting the new document containing the sensitive information from the document repository containing the new document. In some embodiments, the method comprises (e) comprises allowing the user to select and download the one or more documents referenced by the search result. In some embodiments, the method comprises (e) automatically providing the sensitive information to an approver for review. In certain embodiments, the method comprises (f) deleting the new document in response to receiving a deletion approval from an approver following (e). In certain embodiments, the sensitive information comprises at least one of personally identifiable information (PII) and profanity. In certain embodiments, the method further comprises (e) sorting by a generative artificial intelligence (AI) model the plurality of documents into separate topics. In some embodiments, the method further comprises (e) interrogating the index in response to receiving a search query from a user, (f) providing a search result to the user, the search result referencing one or more documents of the plurality of documents sourced from the plurality of document repositories associated with the search query, (g) receiving a question from the user regarding the documents referenced in the search result; and (h) providing by a generative artificial intelligence (AI) model an answer to the user responsive to the question and based on information contained in the documents referenced in the search result.

An embodiment of a computer implemented method for providing access to documents across a plurality of separate document repositories comprises: (a) extracting content from a plurality of documents stored in one or more storage containers and sourced from a plurality of separate document repositories, (b) providing an index containing the extracted content of the plurality of documents sourced from a plurality of separate document repositories, and (c) sorting by a generative artificial intelligence (AI) model the plurality of documents into separate subject matter topics. In some embodiments, the method further comprises (d) interrogating the index in response to receiving a search query from a user, and (e) providing a search result to the user, the search result referencing one or more documents sourced from the plurality of document repositories associated with the search query and wherein the one or more documents are sorted by their respective subject matter topics. In certain embodiments, the method further comprises (d) receiving a question from the user regarding the documents referenced in the search result; and (e) providing by the generative AI model an answer to the user responsive to the question and based on information contained in the documents referenced in the search result. In some embodiments, the generative AI model comprises a large language model (LLM). In some embodiments, the method comprises (d) extracting content from a new document in response to the uploading of a new document to one of the plurality of document repositories, and (e) automatically detecting for the presence of sensitive information in the extracted content of the new document. In certain embodiments, the method further comprises (f) deleting the new document containing the sensitive information from the document repository containing the new document.

An embodiment of a computer implemented method for providing access to documents across a plurality of separate document repositories comprises: (a) extracting content from a plurality of documents sourced from a plurality of separate document repositories, (b) providing an index containing the extracted content of the plurality of documents sourced from a plurality of separate document repositories, (c) interrogating the index in response to receiving a search query from a user, (d) providing a search result to the user, the search result referencing one or more documents sourced from the plurality of document repositories associated with the search query, (e) receiving one or more prompts from the user regarding the documents referenced in the search result; and (f) providing by a generative artificial intelligence (AI) model a response to the user responsive to the one or more prompts and based on information contained in the documents referenced in the search result. In some embodiments, the method further comprises (g) extracting by the generative AI model content from the plurality of documents sourced from the plurality of document repositories to construct a data visualization based on the one or more prompts, wherein the data visualization comprises a knowledge tree. In certain embodiments, (e) comprises extracting by the generative AI model tabular or graphical data contained in the documents referenced in the search result. In certain embodiments, (e) comprises extracting by the generative AI model metadata from the documents referenced in the search result. In some embodiments, the method further comprises (g) extracting content from a new document in response to the uploading of a new document to one of the plurality of document repositories and (h) automatically detecting for the presence of sensitive information in the extracted content of the new document.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIGS. 1-4 are block diagrams of different use cases of cloud search systems according to some embodiments;

FIGS. 5 and 6 are block diagrams of cloud search system according to some embodiments;

FIGS. 7 and 8 are integration flow diagram of cloud search system according to some embodiments;

FIG. 9 is a block diagram of an indexing system according to some embodiments;

FIG. 10 is a block diagram of a sensitive information screening system according to some embodiments;

FIG. 11 is an integration flow diagram of a sensitive information screening system according to some embodiments;

FIG. 12 is an integration flow diagram of a metadata cleaning system according to some embodiments;

FIG. 13 is a block diagram of a computer system according to some embodiments; and

FIGS. 14-17 are flowcharts of computer implemented methods for providing access to documents across a plurality of separate document repositories is shown according to some embodiments.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As described above, search engines, including cloud search services or systems, allow for the management and retrieval of documents spread across different repositories. Conventional search engines, when employed in the cloud or on-premises, follow a fundamental process of document indexing and user query processing, leveraging techniques like keyword-based searching, natural language processing, and machine learning. Despite the utility of such search engines, they are subject to several limitations, particularly in the context of contemporary cloud search systems.

As an example, contemporary cloud search systems sometimes suffer from limited semantic understanding. Conventional search engines, including cloud search systems, primarily rely on keyword-based indexing and searching. This approach may struggle in at least some instances to understand the semantics and context of user queries, resulting in search results (generated in response to a keyword-based query) that are not always aligned with user's intent. In addition, contemporary cloud search systems can suffer from undue cross-repository search complexity. Particularly, when dealing with different types of data (e.g., different types of electronic files or documents) stored across multiple cloud platforms and on-premises repositories, conducting efficient cross-repository searches can be complex and may require custom integrations, leading to resource and time-consuming efforts. In addition, cloud search systems typically handle a wide range of data types, from structured to unstructured data, and typically require users to construct complex queries to search effectively. This can pose a barrier for non-technical users and diminish the overall search experience. In a further example, contemporary cloud search systems raise security and data privacy concerns. Specifically, search engines, when applied to cloud services, must adhere to stringent security and data privacy regulations. Conventional solutions may have inherent limitations in this regard, potentially jeopardizing sensitive data.

Accordingly, embodiments of systems and methods are disclosed herein which overcome at least some of the challenges associated with search engines including contemporary cloud search systems, providing enhanced scalability, user-friendliness, cost-effectiveness, semantic understanding, and cross-repository search capabilities. Particularly, embodiments of cloud search systems are disclosed herein that combine knowledge management tools with artificial intelligence (AI)-based search capability. By utilizing embodiments of cloud search systems disclosed herein, documents across multiple repositories can be accessed, indexed, and surfaced within only a few seconds. Once the documents are surfaced, embodiments of cloud search systems disclosed herein provide features to download, extract or apply generative AI tools for insights. In addition, embodiments of cloud search systems disclosed herein enforce role-based security and information protection on personally identifiable information (PII) and confidential data contained in documents.

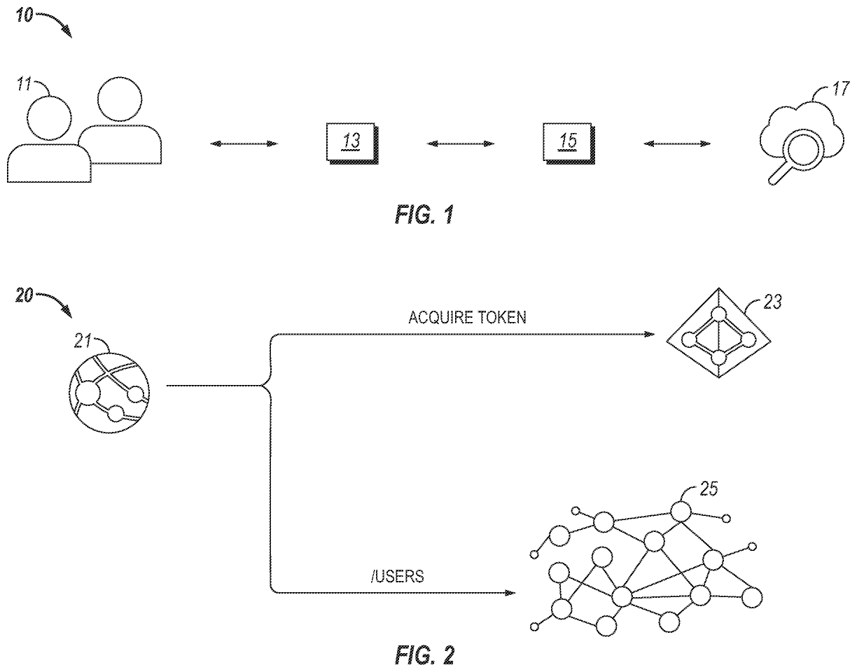

Embodiments of cloud search systems disclosed herein may be implemented in accordance with various distinct use cases. For example, in FIGS. 1-4, embodiments of cloud search systems 10, 20, 30, and 40 are shown configured to address at least some of the challenges of contemporary cloud search systems outlined above.

Referring now to FIG. 1, a block diagram of a first use case 10 of an embodiment of a cloud search system is shown and which illustrates processing of a document search in accordance with principles disclosed herein. In an embodiment, a user 11 may enter a search query that is received via a user interface (UI) 13 for executing a search of a plurality of document separate document repositories using a search engine 17. In some embodiments, search engine 17 may leverage features or functionalities provided by existing cloud search systems such as, for example, the Azure Cloud search system of the Microsoft Azure® Cloud Platform provided by the Microsoft Corporation of Redmond, Washington. The search query provided by the user 11 may be based on a keyword from a search index, such as an Azure® search index, or any other alphanumeric entry. In this exemplary embodiment, the user interface comprises a web application (e.g., an Angular UI web application which in turn calls a backend search function 15 (e.g., a Nodejs function application). As used herein, a “call” refers to the specific request initiated by one software application to another, aiming to access its functionality or data. The backend search function 15 of use case 10 hosts the business logic necessary for making calls to the search engine 17. In addition, backend search function 15 acts as a search backend service between the user interface 13 and the search engine 17. In this manner, documents across multiple document repositories may be accessed within seconds. Thus, once a query is initiated, the search engine 17 returns documents to the user 11 based on, for example, indexed data that contains filepath and/or uniform resource locator (URL) identifying where the document is stored so the user may directly access the selected document.

Referring now to FIG. 2, a schematic diagram of a second use case 20 of an embodiment of a cloud search system is shown and which illustrates retrieval of a selected document in accordance with principles disclosed herein. In this exemplary embodiment, a selected document may be retrieved by the user by downloading the selected document using, for example, a link to a filepath or URL (e.g., supplied by the search engine 17 of first use case 10). Thus, once the user receives the search result, the user may open the document by clicking the document hyperlink using, for example, a web application 21. The hyperlink may also be shared (e.g., via email) from the user interface (e.g., user interface 13 shown in FIG. 1) to other persons with valid access to the document. Security may be enforced by acquiring a token of the user from a security directory 23 (e.g., Azure® Active Directory provided by the Microsoft Corporation) identifying which users have access to which documents through the creation and maintenance of a plurality of separate security groups. The token received from the security directory 23 may be passed to a document retrieval API 25 (e.g., Microsoft Graph provided by the Microsoft Corporation) that authenticates the user and then downloads the selected document.

In this manner, the token establishes the user's authenticity while the document retrieval API 25, which carries the token, presents the list of access or security groups to which the user belongs. Particularly, in this exemplary embodiment, each data source or document repository has a one-to-one mapping to each security group. Thus, the user's access to a selected document repository is defined by the user's presence in a security group that is mapped specifically to the selected document repository to maintain data privacy and security. In some instances, an authenticated user with access to a given security directory may not be able to access a given document from the security directory if the document is restricted for business or operational reasons such as, for example, when a document is subject to an ongoing investigation or litigation. In some embodiments, the authentication process is the same on the recipient's end.

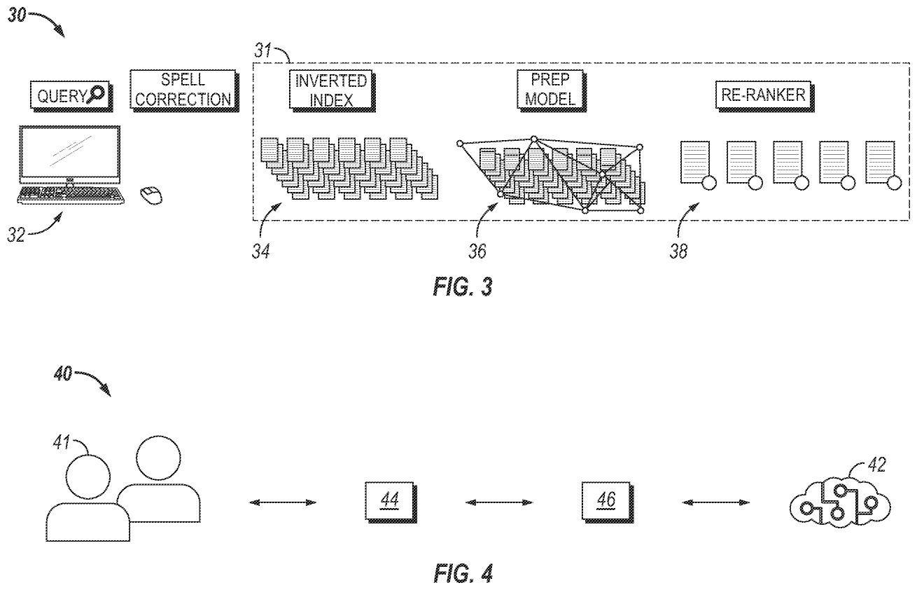

Referring now to FIG. 3, a schematic diagram of a third use case 30 of an embodiment of a cloud search system is shown and which illustrates an advanced or semantic search in accordance with principles disclosed herein. In this exemplary embodiment, a search engine 31 validates a search request received from a user 32, and based on the parameters of the search request, prepares a search query which is applied to an initial index 34 referencing documents from one or more separate document repositories. In addition, the search engine 31 transforms (indicated by arrow 36 in FIG. 3) the initial index 34 to agreed formats and returns re-ranked search results 38 back to the user 32.

In an embodiment, relevant search results may be returned and contextually ranked based on the context around the search query provided by the user 32. For example, if the query is misspelled, and the context is understood, relevant search results 38 related to the query may be returned. In some instances, the context may be extracted based on search history or perceived intent of the user, such as through the use of machine learning techniques. For example, a semantic configuration which specifies how fields are used in semantic ranking may be applied by the search engine 31. In this manner, the semantic configuration gives the underlying model hints about which index fields are most important for semantic ranking, highlights, and answers, such that documents semantically close to the intent of the original query are returned when a search query is initiated by the user 32. In certain embodiments, a caption for the search query is returned to the user 32 by the search engine 31 along with the search results 38. For example, if the search query is “HIPAA”, the general intent may be surmised by the search engine 31 as understanding the purpose of “HIPAA.” Thus, the search query may be semantically interpreted by the search engine 31 as “what is HIPAA?”, and “definition/purpose of HIPAA” may be included as a caption for the returned search results 38.

Referring now to FIG. 4, a block diagram of a fourth use case 40 of an embodiment of a cloud search system is shown and which how data is extracted to generate insights from documents contained in one or more document repositories in accordance with principles disclosed herein. In this manner, a search engine 42 validates a search request received from a user interface 44 (e.g., a web application). In addition, the search engine 42, based on the received search request, extracts content from a document index and checks the size of the actual text content of returned documents as part of making a call to a summarizer function 46 (e.g., a python function application) that formulates and returns a summary of the returned documents along with a listing of topics which are found in the returned documents. The duration of the summarization provided by the summarizer function 46 may depend on the size of the returned documents and matching topics. For example, if the content of the returned documents is large, a prompt may be displayed to the user 41 about the approximate time it will take to summarize the returned documents. If the user 41 accepts, then the summarizer function 46 is called by the search engine 42.

In an embodiment, the user 41 may extract data from one or more selected documents and generate insights based on information contained in the returned documents. For example, upon clicking a summarization icon next to a returned document listed in a user interface 44, the selected document summary may be generated within seconds whereby a call is made to the search engine 42 which in turn makes a call to the summarizer function 46 for text summarization.

In some embodiments, insights may be generated by extracting tabular data using, for example, a representational state transfer (REST) API call to a machine learning based optical character recognition (OCR) function (e.g., Azure® Form Recognizer provided by the Microsoft Corporation) for capturing text from the returned documents. At the backend, once the OCR extraction is complete and stored (e.g., in a CSV file), a notification (e.g., an email notification) is provided to the user 46 with the corresponding OCR extraction file provided as an attachment along with a link to view the original content.

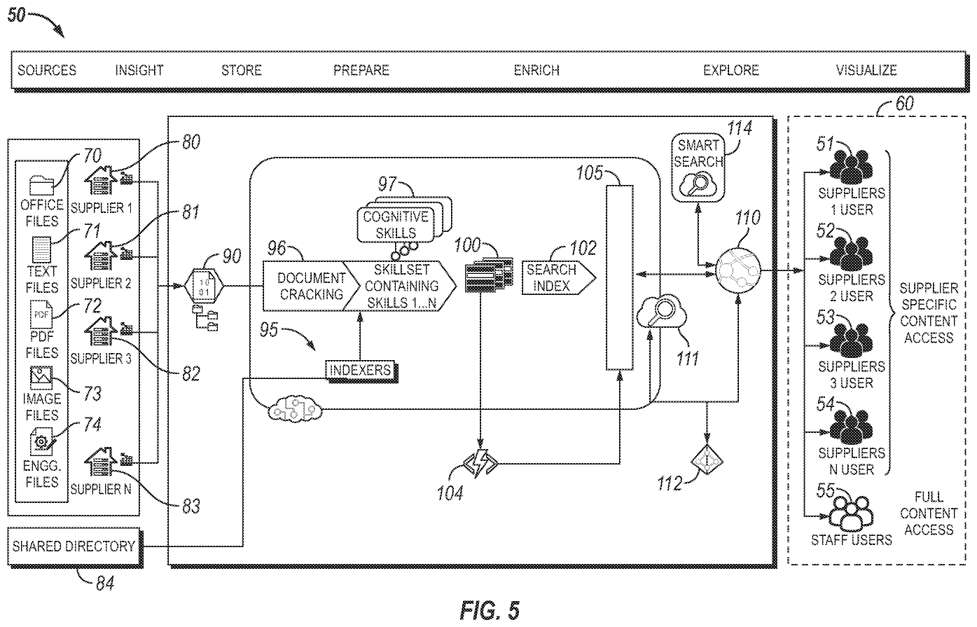

Referring to FIG. 5, a block diagram of an embodiment of a cloud search system 50 is shown implementable through the various use cases 10, 20, 30, and 40 described above. In this exemplary embodiment, cloud search system 50 includes a user interface 60 (e.g., a web application such as an Angular UI web application) for displaying search results and related information to various users 51-55 of the cloud search system 50. Multiple features such as filters, word clouds, date sliders, and document search highlights may be presented to the users 51-55 via the user interface 60. In addition, access to the underlying data may be managed using a document retrieval function (e.g., a Microsoft Graph API).

Cloud search system 50 supports searching across a variety of different document or file classes including, among other things, office files 70 (e.g., word processing documents, presentation documents, email documents, spreadsheet documents), text files 71, portable document format (PDF) files 72, image files 73, and engineering files 74 (e.g., computer aided drafting (CAD) files, three-dimensional (3D) modeling files, computation fluid dynamics (CFD) files).

The different classes of documents or files 70-73 are sourced from a plurality of separate and distinct document repositories 80-83 (labeled as “supplier” in FIG. 5) where each document repository may contain one or more of the different file classes 70-73. In addition, the files or documents for each document repository 81-83 is stored in a corresponding storage container 90 (e.g., blob storage containers) as unstructured data. As used herein, the term “unstructured data” refers to data that does not adhere to a particular model or definition, such as text or binary data. Varying classes of files may be stored in the storage containers 90 including complex files such as image and video files.

As an example, the information (e.g., comprising one or more of the document classes 70-73) of a first document repository 80 may be stored in a first storage container 90, the information of a second document repository 81 may be stored in a separate second storage container 90, and so on and so forth. Thus, each document repository 80-83 corresponds to a different storage container 90 which stores the information of the given document repository 80-83.

In addition to the information contained in storage containers 90, the cloud search system is also configured to search information sourced from one or more shared file directories or platforms 76. The shared filed directories 76 may comprise information shared across different authorized users via a network such as the Internet. Such shared file directories 76 may include, for example, Azure® Files, Azure® SQL Database, Yammer, SharePoint and Teams web services provided by the Microsoft Corporation.

In this exemplary embodiment, the information stored in the repository specific storage containers 90 is indexed by a plurality of file indexers 95. Particularly, each document repository 80-83 is mapped to a separate storage container 90, which is in turn mapped to one or more specific file indexers 95. To state in other words, each document repository 80-83 is associated with its own specific storage container 90 and its own one or more specific file indexers 95. In this exemplary embodiment, a unique pair of file indexers 95 is mapped or linked to each document repository 80-83 (and the shared directory 84); however, the number of unique file indexers 95 mapped to each document repository 80-83 (and the shared directory 84) may vary in other embodiments. For the sake of simplicity, elements 80-84 are referred to herein collectively as document repositories 80-84.

The file indexers 95 perform one or more distinct operations on the information contained in the storage containers 90 assigned to the given file indexers 95. Generally, file indexers 95 “index” the unindexed information contained in the storage containers 90. As part of this process, file indexers 95 may apply other operations such as relevance tuning, semantic ranking, autocomplete, synonym matching, fuzzy matching, filtering, and sorting. Particularly, in this exemplary embodiment, file indexers 95 are each configured to perform document cracking via a document cracking function 96 whereby file indexers 95 open the files contained within the specific file containers 90 linked to the given file indexers 95 and extract content therefrom such as text-based content.

Additionally, in this exemplary embodiment, file indexers 95 are equipped with artificial intelligence (AI) tools or functions 97 providing machine learning capabilities as an extension to the indexing functionality provided by file indexers 95. AI functions 97 provision file indexers 95 with the ability to extract images and other entities from unindexed files, perform language analysis, translate text, extract text embedded within files (e.g., OCR-based text extraction), and infer text and structure from non-text files by analyzing the content of the given file.

In some embodiments, through the document cracking 96 and AI functions 97, file indexers 95 are configured to provide enriched contents 100 and one or more search indexes (or other structures) 102. The enriched contents 100 contain the objects and other information extracted from the unindexed files operated on by the file indexers 95. The content of enriched contents 100 is in-turn captured in the one or more search indexes 102 which may be mapped to specific storage containers 90 (e.g., each storage container 90 is mapped to a unique search index 102).

The contents of the one or more search indexes 102 are integrated, in this exemplary embodiment, into a single global or common index 105 that contains searchable information sourced from each of the document repositories 80-84. The contents of the common index 105 is searchable by users of the cloud search system 50, thereby permitting the users to potentially search (depending on the user's authorization) each of the document repositories 80-84 using the single common index 105.

In this exemplary embodiment, the contents of the enriched contents 100 are fed to a sensitive information detection function 104 (e.g., embodied in a software function) configured to detect the presence of sensitive information in the enriched contents 100. As used herein, the term “sensitive information” refers to either explicit material (e.g., profanity) or personally identifying information (PII) such as social security numbers, credit card information, passport information, driver's license information, and the like. The sensitive information detected or identified by detection function 104 may be flagged in the common index 105 to ensure documents containing such sensitive information may not be accessed (e.g., they are not made available for search or download) by the users 51-55 of (cloud search system 50.

As described above, the users 51-55 of cloud search system 50 may search the documents contained in the different document repositories 80-84 using the common index 105. Particularly, in this exemplary embodiment, users 51-55 may interact with cloud search system 50 through a user interface 110 thereof which may be in the form of a web application service. Using the user interface 110, the users 51-55 may enter one or more search queries applied to the common index 105 via, for example, a search query function 111. In some embodiments, search query function 111 comprises features of the Azure® Cognitive Search service provided by Microsoft.

In this exemplary embodiment, security may be enforced using a security directory 112. For example, the security directory 112 may be token-based in which the particular security groups to which a given user 51-55 belongs is identified in order to determine which of the data repositories 80-84 the given user 51-55 is authorized to access. In this manner, the user 51-55 is limited to accessing only those documents sourced from the document repositories 80-84 to which the user 51-55 has been granted access as determined by the security directory 112.

In this exemplary embodiment, the search query (e.g., in the form of a keyword search) entered by the given user 51-55 may trigger the execution of a smart search function 114 of the cloud search system 50. The smart search function 114 may search the common index 105 for, in addition to the keywords contained in the search query, related words and synonyms of the search query such that there is no need for the user 51-55 to input any syntax into their search query.

In some embodiments, a search query may be executed using the cloud search system 50 through the following exemplary steps: initially upon receiving a search term or string (e.g., entered via the user interface 110) from a user 51-55, the user 51-55 may be authenticated whereby the security directory 112 (via, e.g., a graph API) identifies the security groups to which the user 51-55 belongs which in-turn determines to which of the document repositories 80-84 the user 51-55 is authorized to access. Based on the authorized document repositories 80-84, a count of documents from the common index 105 may be returned.

In addition, any stop words (e.g., commonly used words such as articles, pronouns and prepositions) included in the search term as part of preparing a search query. A list of searchable documents may be obtained to which a prohibited tag has been attached such that these prohibited tagged documents may be excluded from the search. Documents tagged as prohibited may include documents restricted for business or operational reasons such as, for example, documents subject to an ongoing investigation or litigation. The search query may then be executed and applied to the common index 105 in order to return a search result.

In some embodiments, the search result is checked to determine if any of the documents referenced in the search result have restricted access, and if so, the access permissions may be consulted for the given restricted access documents to determine if the restricted access documents may be included in the search result to the given user 51-55 (e.g., based on the user's 51-55 credentials). In some embodiments, duplicative and/or irrelevant metadata may be trimmed from the search result, and the trimmed search result may be presented to the user 51-55 via the user interface 110 in the form of one or more filters.

Upon receiving the trimmed search result, the user 51-55 may select a given document referenced in the trimmed search result. Based on the identity of the selected document, the content of the selected document may be retrieved by the cloud search system 50 from its given storage container 90 and the selected document may be displayed to the user 51-55.

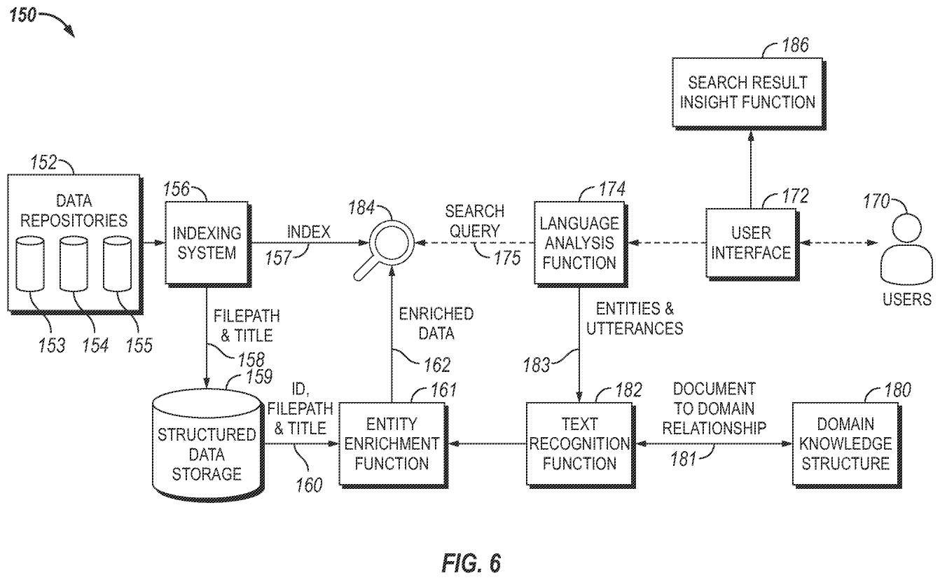

Referring to FIG. 6, a block diagram of another embodiment of a cloud search system 150 is shown implementable through the various use cases 10, 20, 30, and 40 described above. For convenience, index traffic is indicated in FIG. 6 by solid arrows while search query traffic is indicated in FIG. 6 by dashed arrows. Cloud search system 150 includes a plurality of storage containers 152 housing files or documents from a corresponding plurality of document sources 153-155 such as, for example, file directories (including shared file directories) and APIs. In addition, cloud search system 150 includes an indexing system 156 comprising one or more different indexers that construct an index 157 (e.g., a common index such as the common index 105 shown in FIG. 5) including contents sourced from each of the plurality of storage containers 152 and sourced from each of the data sources 153-155.

Cloud search system 150 additionally includes structure data storage 158 that includes structured data 158 extracted from the documents sourced from the plurality of storage containers 152 by the indexing system 156. The structured data 158 extracted by indexing system 156 includes standardized, clearly defined, and searchable data particularly including the filepath and title information of the documents stored in the plurality of storage containers 152. In this exemplary embodiment, cloud search system 150 includes an entity enrichment function 161 which receives at least some of the structured data 158 (e.g., identification (ID), filepath, and title information) from the structured data storage 159 and enriches the structured data 158 to produce enriched data or contents 162 by employing language and/or image analysis (e.g., through the activation of one or more corresponding AI functions of the enrichment function 161). In this manner, the enrichment function 161 may extract text, translate text, and/or infer text or other structures from the structured data 158 to provide the enriched data 162.

The cloud search system 150 includes a user interface 172 (e.g., a web services application) accessible by one or more users 170 of the system 150. In this exemplary embodiment, cloud search system 150 includes a language analysis function 174 for applying language analysis (e.g., via one or more AI functions) to a search term entered by the user 170 using the user interface 172. The language analysis function 174 is configured to infer the search intent of the user 170 based on the search term entered by the user and an AI-driven natural language model whereby important information in the form of a search query 175 may be extracted from the search term. In some embodiments, the language analysis function 174 may comprise one or more features of the Azure® AI Language service provided by Microsoft.

To assist language analysis function 174 in formulating the search query 175, in this exemplary embodiment, cloud search system 150 includes both a domain knowledge structure 180 and a text recognition function 182. Particularly, domain knowledge structure 180 contains one or more data structures e.g., knowledge graphs) that provides a taxonomy of the different knowledge domains encompassed by the documents stored in the plurality of storage containers 152. In this manner, domain knowledge structure 180 identifies a document to domain relationship 181 between one or more documents stored in the plurality of storage containers 152 and one or more domains identified in the knowledge structure of domain knowledge structure 180.

The document to domain relationship 181 identified by domain knowledge structure 180 may provide contextual information for assisting language analysis function 174 in inferring the user's 170 intent behind a given entered search term. Particularly, in this exemplary embodiment, the text recognition function 182 is applied to the document to domain relationship 181 identified by domain knowledge structure 180 to extract pertinent information (e.g., entities and utterances) 183 which may be provided to the language analysis function 174 to assist function 174 in formulating the search query 175. In addition, in this exemplary embodiment, information extracted by text recognition function 182 from the document to domain relationship 181 is provided to the entity enrichment function 161 to assist function 161 in providing enriched data 162.

Cloud search system 150 includes a search query function 182 that is configured, in response to receiving a search query 175, return a search result to the user 170 by consulting the index 157 provided by indexing system 156 and/or the enriched data 162 provided by entity enrichment function 161. The search result may reference one or more documents or files stored in the plurality of storage containers 152 and which are responsive to the search query 175 received by the search query function 182. In some embodiments, search query function 182 comprises features of the Azure® Cognitive Search service provided by Microsoft. The search result may be in the form of references to one or more documents stored in the plurality of storage containers 152, selected contents from the one or more documents, and/or links to download the one or more documents.

In this exemplary embodiment, cloud search system 150 includes a search result insight function 186 configured to automatically provide insights to the users 170 pertaining to search results returned by the cloud search service 150. For example, upon receiving a search result, a user 170 may make queries to the search result insight function 186 regarding the search result. For example, the user 170 may ask the search result insight function 186 to summarize one or more of the documents referenced in the search result (or to provide a global summary of the search result). In another example, the user 170 may ask the search result insight function 186 to answer one or more true or false questions regarding the search result (e.g., does the search result state “X”? does the search result contain “Y” ? and so on and so forth).

In this manner, search result insight function 186 may answer different questions from the user 170 pertaining to the search result so that the user 170 may not necessarily be required to read through some or each of the documents referenced in the search result. Instead, the user 170 may quickly and conveniently consult the search result insight function 186 to obtain whatever information is specifically desired by the user 170 without requiring the user 170 to laboriously read through the documents referenced in the search result his or herself in order to obtain the desired information. In some embodiments, search result insight function 186 comprises or interfaces with a generative AI model such as a large language model (LLM) configured for general-purpose language understanding and generation. By leveraging such a generative AI model, the search result insight function 186 may automatically understand the meaning of prompts inputted by the user 170 regarding the search result (the generative AI model having already ingested the content of the documents referenced in the search result) such that function 186 may quickly and automatically respond to the prompt to the satisfaction of the user 170.

In some embodiments, in addition to answering questions or other prompts from user 170, the search result insight function 186 may employ a generative AI model for other purposes, such as for organizing the various documents stored in the storage containers. For example, the generative AI model may sort the plurality of documents according to their respective subject matter topics. In addition, the generative AI model may construct data visualization structures such as knowledge trees based on the plurality of documents and potentially the prompts provided by the user 170.

In some embodiments, cloud search system 150 may include an application insight function configured to provide insights (e.g., telemetry including web server and/or web application telemetry, performance, counters, and other performance-related information) to an operator of the cloud search service 150 regarding the performance and resource utilization of the cloud search system 150. The application insight function may permit the operator of cloud search system 150 to monitor the health, performance, and usage of cloud search system 150. In some embodiments, application insight function comprises the Azure® Application Insights service provided by Microsoft.

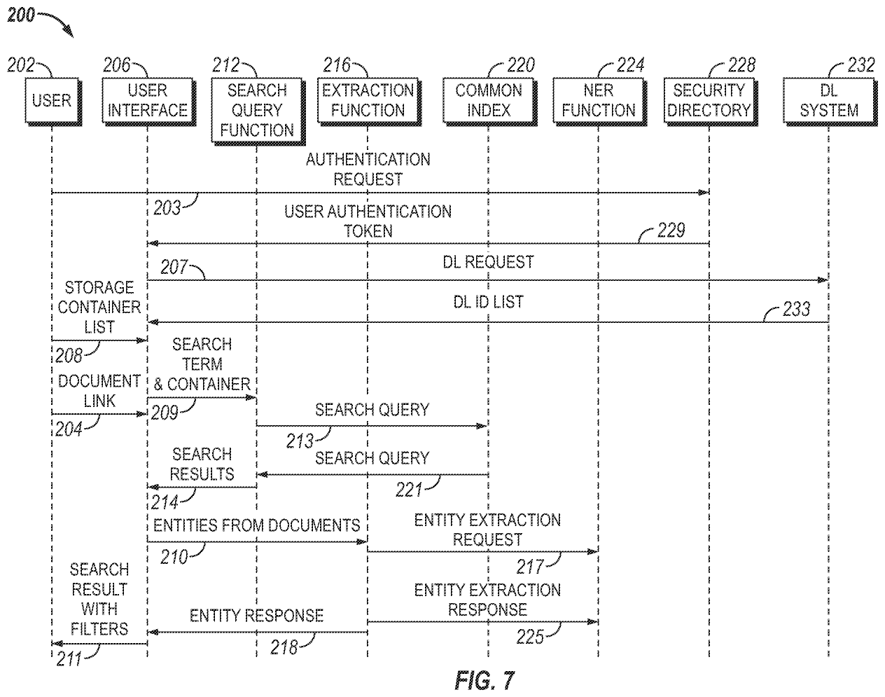

Referring to FIG. 7, an integration flow diagram of another embodiment of a cloud search system 200 is shown implementable through the various use cases 10, 20, 30, and 40 described above. Initially, in this exemplary embodiment, a user 202 of cloud search system 200 may provide an authentication request 203 (e.g., in response to logging into the system 200, entering a search term into the system 200) to a security directory 228 of the cloud search system 200. In return, the security directory 228 is configured to provide an authentication token 229 to a user interface 206 of the cloud search system 200. The authentication token 229 may identify one or more security groups or distribution lists (DLs) kept by a DL system 232 of the cloud search system 200 to which the specific user 202 is authorized by security directory 228 to access.

Based on the authorization token 229 provided by the security directory 228, the user interface 206 of cloud search system 200 provides a DL request 207 to the DL system 207. Particularly, the DL request 207 requests the DLs to which the specific user 202 is authorized to access based on the authentication token 229. The DLs of DL system 232 may be mapped to different document repositories of the cloud search system 200 whereby a first DL is mapped to a first document repository, a second DL is mapped to a second document repository, and so on and so forth. The DL system 232 returns a DL ID list 233 identifying the specific DLs to which the user 202 is permitted to access given the authentication token 229 provided by security directory 228. In turn, in some embodiments, the user interface 206 provides to the user 202 a source or storage container list 208 identifying the specific storage containers (housing the document repositories of the cloud search system 200) mapped to the DLs specified in the DL ID list 233.

Having been authorized access to at least some of the document repositories of cloud search system 200, the user 202 may enter a search term 204 into the user interface 206 whereby the user interface 206 may provide to a search query function 212 of cloud search service 200 the search term along with the list of storage containers (indicated by arrow 209 in FIG. 7) to which the user 202 is permitted to access (e.g., the storage containers mapped to the DLs associated with the authentication token 229). In some embodiments, the search query function 212 of cloud search system 200 is similar in configuration as the search query functions 111 and/or 184 shown in FIGS. 5 and 6, respectively. The search query 212 generates a search query 213 based on the search term and list of corresponding storage containers 209 and provides the search query 213 to a common index 220 (e.g., an index similar in configuration to the common index 105 shown in FIG. 5) whereby a search response 221 is obtained by the search query function 212 from the common index 220. In turn, the search query function 212 generates a search result 214 (e.g., referencing one or more selected documents of the cloud search system 200) and provides the search result 214 to the user interface 206.

In this exemplary embodiment, cloud search system 200 includes an extraction function 216 which receives contents (including metadata) of the one or more documents referenced by the search result 214 and forwards named entity data provisionally identified in the one or more documents, and forwards the provisionally identified named entity data of the one or more documents as an entity extraction request 217 to a named entity recognition (NER) function 224 of the cloud search system 200. As used herein, the term “named entity data” comprises metadata naming or otherwise identifying specific people, locations, and organizations. As will be discussed further herein, the NER function 224 identifies any duplicative data and junk data contained within the named entity data which the NER function 224 extracts from the one or more documents as an entity extraction response 225. The extracted entities are provided by the extraction function 216 to the user interface 206 as an entity response 208. In turn, the user interface 206 presents the extracted entities to the user 202 in the form of filters which accompany the search result 211 (indicated by arrow 211 in FIG. 7).

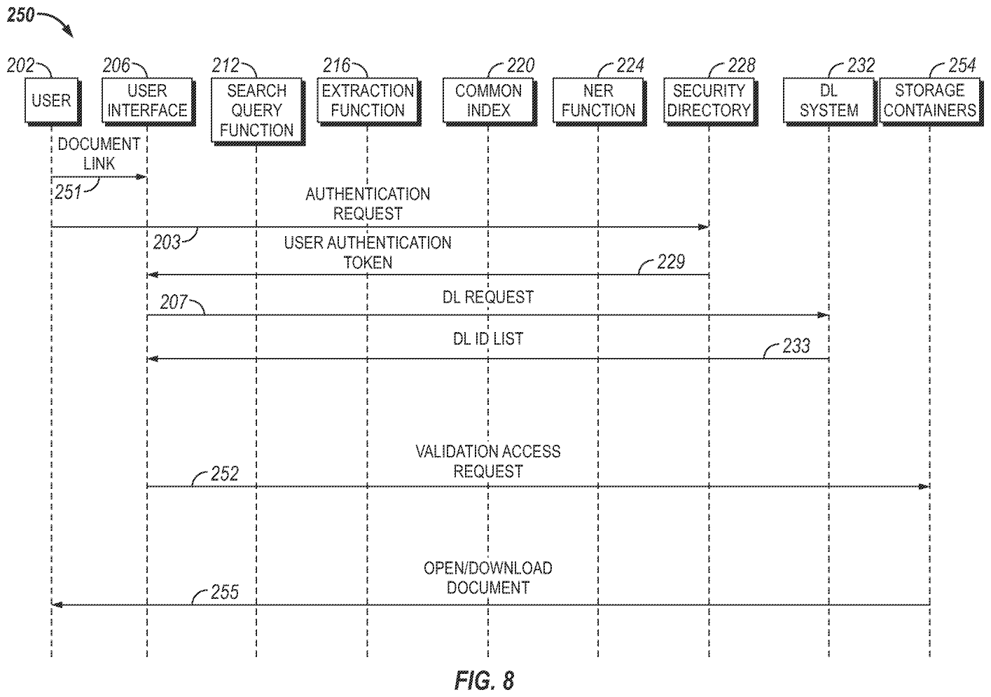

Referring to FIG. 8, an integration flow diagram of another embodiment of a cloud search system 250 is shown implementable through the various use cases 10, 20, 30, and 40 described above. Cloud search system 250 includes features in common with the cloud search system 200 shown in FIG. 7, and shared features are labeled similarly. Particularly, cloud search system 250 is similar to the cloud search system 200 but corresponds to a use case where the user 202 requests access to a specific document. Particularly, the user may enter a document link 251 into the user interface 206 referencing a document stored in on the storage containers of cloud search system 250.

Following authentication (e.g., via operation of security directory 228 and DL system 232) to ensure the user 202 is permitted access to the requested document, the user interface 252 may provide a validated access request 252 to the storage containers 254 of the cloud search system 250 indicating that the document request made by user 202 has been validated. Subsequently, the requested document (or a link to the requested document) is provided (indicated by arrow 255 in FIG. 8) from the storage containers 254 (e.g., from the specific storage container 254 housing the requested document) to the user 202 whereby the user 202 may open or download the requested document.

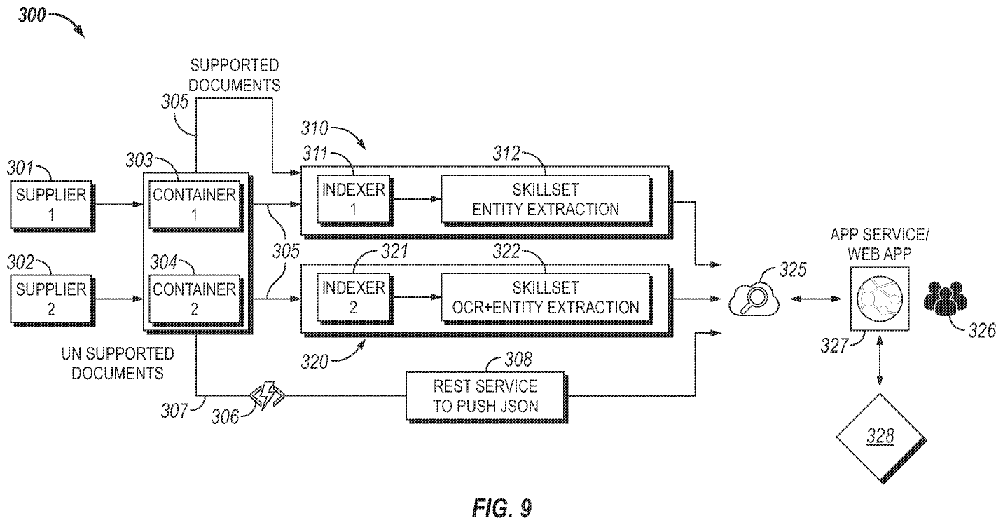

Referring now to FIG. 9, a block diagram of an indexing system 300 is shown according to some embodiments. The indexing system 300 shown in FIG. 9 and described below may be incorporated into the cloud search system 50 shown in FIG. 5. In this exemplary embodiment, indexing system 300 includes a pair of indexers 310 and 320 each comprising an indexing engine 311 and 321 and AI functions 312 and 322, respectively. Indexers 310 and 320 receive information sourced from a pair of document repositories 301 and 302. Particularly, files from the pair of document repositories 301 and 302 are stored in a pair of corresponding storage containers 303 and 304, respectively, where a first indexer 310 receives content from a first storage container 303 while a second indexer 320 receives content from a second storage container 304. In some embodiments, indexers 310 and 320 may be executed periodically (e.g., hourly, daily, weekly) to index newly added or created documents and to update existing documents.

The indexing engines 311 and 321 of indexers 310 and 320, respectively, index the unindexed information stored in containers 303 and 304, respectfully. In addition, AI function 312 of first indexer 310 performs entity extraction on the files stored in a first storage container 303 while AI function 322 of second indexer 320 performs both entity extraction and OCR text recognition on the files stored in a second storage container 304. Particularly, indexers 310 and 320 operate on supported documents or files 305 stored in the containers 303 and 304, respectively. However, a separate metadata extraction function 306 unsupported documents or files 307. Supported documents 305 are documents having a file type or extension that is supported by the indexers 310 and 320 while unsupported documents 307 are documents having a file type or extension that is not supported by the indexers 310 and 320. The metadata extraction function 306 extracts metadata from the unsupported documents 307 and which, along with the information produced from indexers 310 and 320, may be indexed in a global or common index 325. In some embodiments, the metadata extracted by metadata extraction function 306 may be communicated to the common index 325 by a web service such as a Representational State of Transfer (REST) service 308.

The information contained in the common index 325 (sourced from both data repositories 301 and 302) is potentially searchable by users 326 via a user interface 327 (e.g., a web application service). In addition, a security directory 328 may trim the search results provided to the user 326 in response to the user 326 entering a search query, where the trimming of the search results is based on the user's 326 membership in one or more security groups mapped to the specific document repositories 301 and 302.

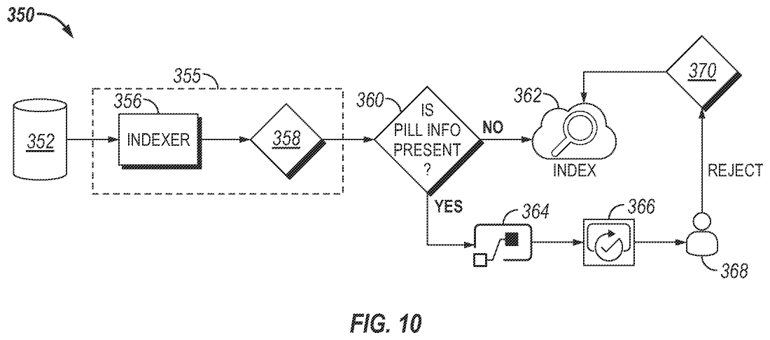

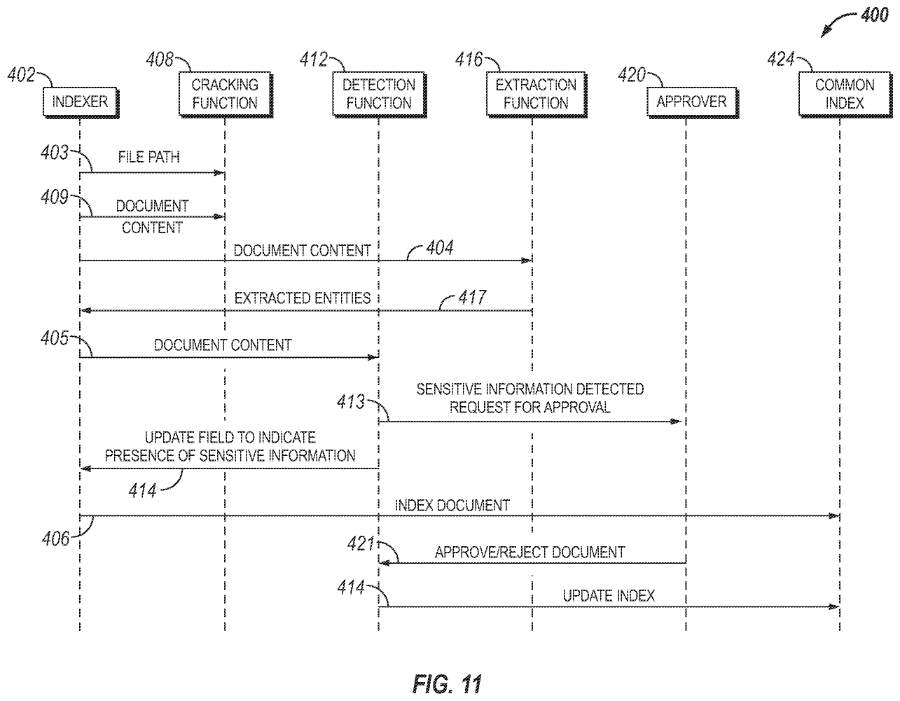

Referring now to FIG. 10, a block diagram of sensitive information screening system 350 is shown according to some embodiments. The screening system 350 shown in FIG. 10 and described below may be incorporated into the cloud search system 50 shown in FIG. 5. In this exemplary embodiment, screening system 350 includes one or more storage containers 352 containing a plurality of documents or files. The documents stored in the containers 352 is provided to an indexer 355 comprising an indexing engine 356 for indexing the information contained in the documents stored in storage containers 352. In addition, indexer 355 comprises a sensitive information detection function 358 (e.g., comprising an AI function) configured to detect the presence of sensitive information in the contents of the documents indexed by the indexing engine 356. The execution of indexer 355 may be periodic and/or triggered by the addition of new documents or files to the one or more storage containers 352.

In this exemplary embodiment, if the presence of sensitive information is not detected in a given document by detection function 358 (indicated at decision block 360 of system 350), then the indexed contents of the document are added to a global or common index 362. Conversely, if the presence of sensitive information is detected in a given document by detection function 358, then the document is flagged by detection function 358 such that the indexed contents of the document are flagged in the common index 362 as containing sensitive information. The indexed sensitive information flag associated with the indexed contents of the document prevent the document from being returned in a search result generated by a cloud search system (e.g., the cloud search system 50 shown in FIG. 5) in response to a search query. Thus, while the flagged document remains at least initially indexed in the common index 362, sensitive information contained in the flagged document is prevented from being accessed by users via the sensitive information flag.

In addition to being flagged as containing sensitive information, the detection of sensitive information by detection function 358 triggers the activation of an automated notification function 364 is triggered by which an approval request 366 is forwarded to an appropriate approver 368. The approver 368 in analyzing the approval request 366 may determine that the flagged document does not contain any sensitive information (e.g., the flagging of the document by the detection function 358 was a false positive) whereby the approver may remove the sensitive information flag from the indexed document (e.g., change a “sensitive information detected” field in the common index 362 from “yes” to “no”).

Conversely, the approver 368 in analyzing the approval request 366 may confirm the presence of sensitive information in the given document. In response to the approver 368 confirming the presence of sensitive information in the flagged document, the flagged document itself may be deleted from the one or more storage containers 352 automatically by a document removal function 235. Alternatively, the flagged document may be moved from its original storage container 352 to a specialized storage container 352 for housing documents containing sensitive information and which is not indexed into the common index 362. The indexer 355 may automatically delete the indexed contents of the document from common index 362 in response to the removal of the document from its storage container 352.

Referring now to FIG. 11, an integration flow diagram of a sensitive information detection system 400 is shown according to some embodiments. The detection system 400 may be employed by a cloud search system to automatically detect and restrict access to documents containing sensitive information and which are searchable by the cloud search system. In some embodiments, the sensitive information detection system 400 shown in FIG. 11 and described below may be incorporated into the cloud search systems 50, 150, 200, and 250 shown in FIGS. 5-8, respectively.

In this exemplary embodiment, detection system 400 includes an indexer 403 (e.g., one similar in configuration to the indexers 310 and 320 shown in FIG. 9) that provides a file path 403 of a document newly added to a storage container of a cloud search system to a document cracking function 408 (e.g., one similar in configuration to the document cracking function 96 shown in FIG. 5) to obtain the content of the added document and provided the document content 409 to the indexer 402. In some embodiments, indexer 402 may comprise an indexing engine of an indexer while cracking function 408 may comprise an additional, supplementary function of the indexer.

The content of the added document may contain one or more embedded entities (e.g., text, images, and other data) that cannot be individually operated upon until they are individually extracted from the document contents. In this exemplary embodiment, the content of the added document is provided (indicated by arrow 404 in FIG. 11) by the indexer 402 to an extraction function 416 of the detection system 400 that is configured to extract one or more specific entities from the contents of the document. The extraction function 416 provides the extracted entities 417 to the indexer 402 which, in this exemplary embodiment, returns the now extracted document content 405 to a sensitive information detection function 412 (e.g., one configured similarly as sensitive information detection function 358 shown in FIG. 1) of the detection system 400.

The detection function 412 detects the presence of any sensitive information contained in the extracted document content 405, and forwards such detected sensitive information 413 to an approver 420 for approval. In addition, detection function 412 instructs (indicated by arrow 414 in FIG. 11) the indexer 402 to update the field of the added document pertaining to the presence of sensitive information to flag the document as containing sensitive information. In response, the indexer 402 indexes 406 the added document in a common index 424 (e.g., one similar in configuration to the common index 95 shown in FIG. 5) of a cloud search system such that the added document is flagged as containing sensitive information and thus cannot be accessed by users of the cloud search system.

In this exemplary embodiment, the approver 420 either approves or rejects (indicated by arrow 421 in FIG. 11) the document and provides the approval/rejection to the detection function 412. In addition, the detection function 412 updates (indicated by arrow 414 in FIG. 11) the common index 424 to reflect the approval or rejection made by the approver 420. For example, in response to receiving a rejection from the approver 420 (indicating that the sensitive information identified by the detection function 412 is not actually sensitive information and instead is a false positive), the detection function 412 may remove the sensitive information flag from the added document such that the document may be accessed by users of a cloud search system. Alternatively, in response to receiving an approval form the approver 420 (indicating that the approver 420 confirms the presence of sensitive information in the added document), the added document may be queued for deletion from its respective storage container.

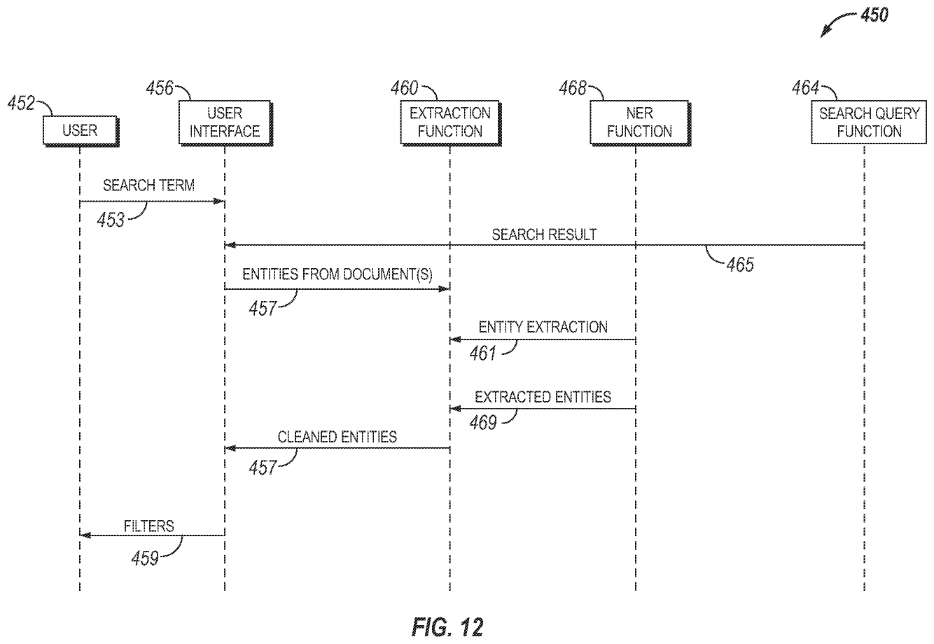

Referring now to FIG. 12, an integration flow diagram of a metadata cleaning system 450 is shown according to some embodiments. The metadata cleaning system 450 may be employed to clean metadata of the searchable documents indexed by a cloud search system so as to improve the quality of the search result returned by the cloud search system. In addition, the metadata cleaning system 450 shown in FIG. 12 and described below may be incorporated into the cloud search system 50 shown in FIG. 5.

In this exemplary embodiment, cleaning system 450 includes a user 452 which may enter a search term or string 453 into a user interface 456 of the metadata cleaning system 450. In response to receiving the search term 453 inputted to the user interface 456, a search query function 464 (which may comprise an AI function) of the metadata cleaning system 450 returns a search result 465 (e.g., via consulting a common index such as the common index 105 shown in FIG. 5) referencing one or more documents associated with the search term 453.

Each indexed document (e.g., indexed in a common index such as the common index 105 shown in FIG. 5) may be operated on (e.g., via an indexer such as the indexer 95 shown in FIG. 5) whereby named entity data or information is provisionally identified and extracted from the indexed document (e.g., extracted to one or more named entity data fields of the index pertaining to the given document).

The metadata cleaning system 450 additionally includes an extraction function 460 which receives the one or more documents referenced by the search result 465 and forwards the provisionally identified named entity data including one or more entities (indicated by arrow 457 in FIG. 12), and forwards the provisionally identified named entity data of the one or more documents (indicated by arrow 461 in FIG. 12) to a named entity recognition (NER) function 468 of the metadata cleaning system 200.

Generally, the provisionally identified named entity data includes, along with authentic named entity data, includes duplicative data (e.g., a duplicative entry of the same named entity data) and/or spurious named entity data (e.g., provisionally identified named entity data that is not actually named entity data) referred to herein as “junk data.” The NER function 468 (which may comprise an AI function) applies textual analysis to the provisionally identified named entity data received from the extraction function 460 and identifies any duplicative data and junk data contained therein whereby the NER function 468 extracts the identified duplicative and/or junk data (indicated by arrow 469 in FIG. 12) from the one or more documents referenced by the search result 465.

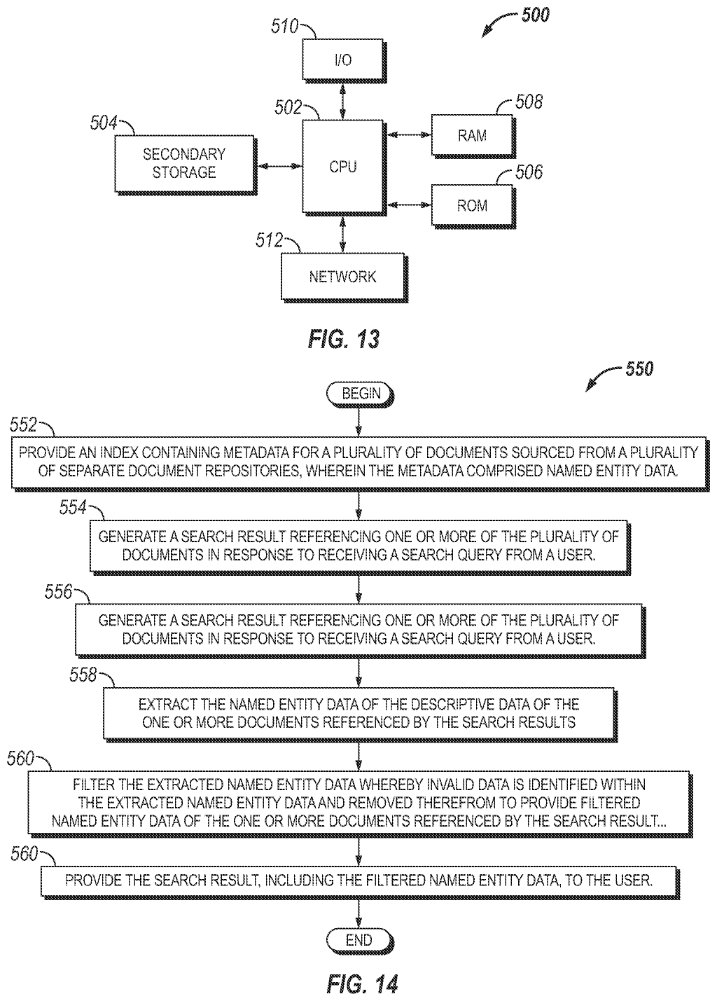

Referring now to FIG. 13, an embodiment of a computer system 500 is shown suitable for implementing one or more components disclosed herein. As an example, computer system 500 may be used to implement the various embodiments of cloud search systems (e.g., cloud search systems 50, 150, 200, and 250 shown in FIGS. 5-8, respectively) disclosed herein.

The computer system 500 of FIG. 13 generally includes a processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. The processor 502 may be implemented as one or more CPU chips. It is understood that by programming and/or loading executable instructions onto the computer system 500, at least one of the CPU 502, the RAM 508, and the ROM 506 are changed, transforming the computer system 500 in part into a particular machine or apparatus having the novel functionality taught by the present disclosure.

Additionally, after the system 500 is turned on or booted, the CPU 502 may execute a computer program or application. For example, the CPU 502 may execute software or firmware stored in the ROM 506 or stored in the RAM 508. In some cases, on boot and/or when the application is initiated, the CPU 502 may copy the application or portions of the application from the secondary storage 504 to the RAM 508 or to memory space within the CPU 502 itself, and the CPU 502 may then execute instructions that the application is comprised of. In some cases, the CPU 502 may copy the application or portions of the application from memory accessed via the network connectivity devices 512 or via the VO devices 510 to the RAM 508 or to memory space within the CPU 502, and the CPU 502 may then execute instructions that the application is comprised of. During execution, an application may load instructions into the CPU 502, for example load some of the instructions of the application into a cache of the CPU 502. In some contexts, an application that is executed may be said to configure the CPU 502 to do something, e.g., to configure the CPU 502 to perform the function or functions promoted by the subject application. When the CPU 502 is configured in this way by the application, the CPU 502 becomes a specific purpose computer or a specific purpose machine.

Secondary storage 504 may be used to store programs which are loaded into RAM 508 when such programs are selected for execution. The ROM 506 is used to store instructions and perhaps data which are read during program execution. ROM 506 is a non-volatile memory device which typically has a small memory capacity relative to the larger memory capacity of secondary storage 504. The secondary storage 504, the RAM 508, and/or the ROM 506 may be referred to in some contexts as computer readable storage media and/or non-transitory computer readable media. VO devices 510 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 512 may take the form of modems, modem banks, Ethernet cards, universal serial bus (USB) interface cards, wireless local area network (WLAN) cards, radio transceiver cards, and/or other well-known network devices. The network connectivity devices 512 may provide wired communication links and/or wireless communication links. These network connectivity devices 512 may enable the processor 502 to communicate with the Internet or one or more intranets. With such a network connection, it is contemplated that the processor 502 might receive information from the network, or might output information to the network. Such information, which may include data or instructions to be executed using processor 502 for example, may be received from and outputted to the network, for example, in the form of a computer data baseband signal or signal embodied in a carrier wave.

The processor 502 executes instructions, codes, computer programs, scripts which it accesses from hard disk, floppy disk, optical disk, flash drive, ROM 506, RAM 508, or the network connectivity devices 512. While only one processor 502 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 504, for example, hard drives, floppy disks, optical disks, and/or other device, the ROM 506, and/or the RAM 508 may be referred to in some contexts as non-transitory instructions and/or non-transitory information.

In an embodiment, the computer system 500 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

Referring now to FIG. 14, a flowchart of a computer implemented method 550 for providing access to documents across a plurality of separate document repositories is shown according to some embodiments. Initially, method 550 begins at block 552 by providing an index containing metadata for a plurality of documents sourced from a plurality of separate document repositories, wherein the metadata comprises named entity data. At block 554, method 550 comprises generating a search result referencing one or more of the plurality of documents in response to receiving a search query from a user. At block 556, method 550 comprises generating a search result referencing one or more of the plurality of documents in response to receiving a search query from a user.

At block 558, method 550 comprises extracting the named entity data of the descriptive data of the one or more documents referenced by the search result. At block 560, method 550 comprises filtering the extracted named entity data whereby invalid data is identified within the extracted named entity data and removed therefrom to provide filtered named entity data of the one or more documents referenced by the search result. At block 562, method 550 comprises providing the search result, including the filtered named entity data, to the user.

In some embodiments, method 550 includes allowing the user to select and download the one or more documents referenced by the search result. In some embodiments, the invalid data comprises at least one of duplicative data and junk data. In some embodiments, the named entity comprises at least one of identifies of people, locations, and organizations. In some embodiments, filtering the extracted named entity data is based on at least one of an identity of one or more people, an identity of one or more locations, an identity of one or more organizations, a creation date, a site name, an identity of an initiator, and an identity of a facility. In certain embodiments, filtering the extracted named entity data is based on a file type, a document type, and a document subtype. In certain embodiments, method 550 includes presenting at least some of the filtered named entity data as one or more filters applicable by the user to filter the search result. In some embodiments, method 550 includes updating the index to associate the filtered named entity data with the one or more documents comprising the filtered named entity data. In certain embodiments, method 550 includes asking a question to all or selected documents using interactive generative AI based machine learning models.

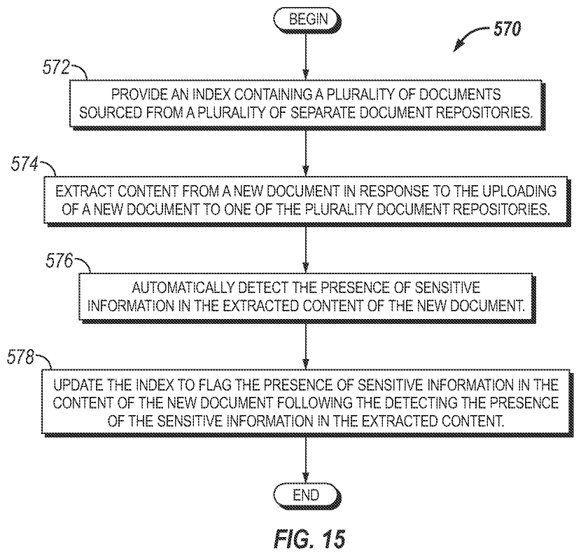

Referring now to FIG. 15, a flowchart of a computer implemented method 570 for providing access to documents across a plurality of separate document repositories is shown according to some embodiments. Initially, method 570 begins at block 572 by providing an index containing a plurality of documents sourced from a plurality of separate document repositories. At block 574, method 570 comprises extracting content from a new document in response to the uploading of a new document to one of the plurality of document repositories.

At block 576, method 570 comprises automatically detecting the presence of sensitive information in the extracted content of the new document. At block 578, method 570 comprises updating the index to flag the presence of sensitive information in the content of the new document following the detecting the presence of the sensitive information in the extracted content.

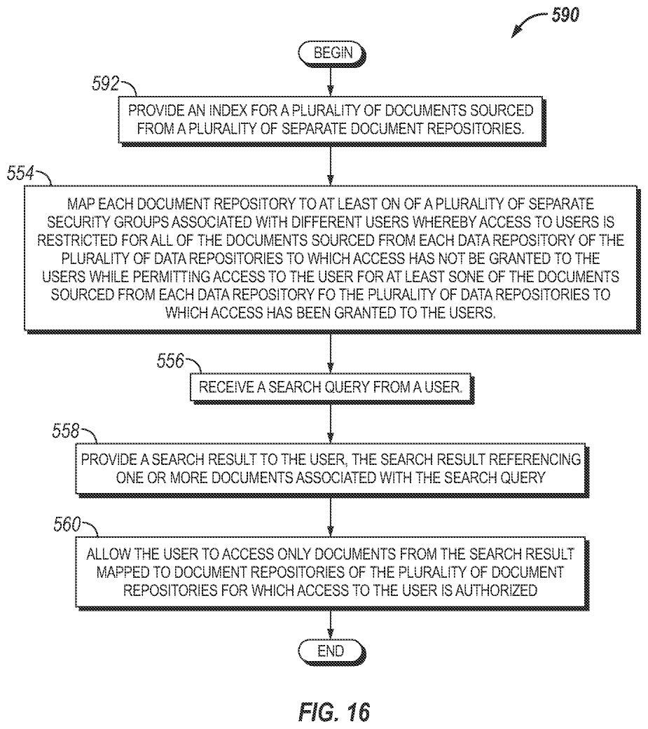

Referring now to FIG. 16, a flowchart of a computer implemented method 590 for providing access to documents across a plurality of separate document repositories is shown according to some embodiments. Initially, method 590 begins at block 592 by providing an index for a plurality of documents sourced from a plurality of separate document repositories. At block 594, method 590 comprises mapping each document repository to at least one of a plurality of separate security groups associated with different users whereby access to users is restricted for all of the documents sourced from each data repository of the plurality of data repositories to which access has not been granted to the users while permitting access to the users for at least some of the documents sourced from each data repository of the plurality of data repositories to which access has been granted to the users.

At block 596, method 590 comprises receiving a search query from a user. At block 598, method 590 comprises providing a search result to the user, the search result referencing one or more documents associated with the search query. At block 600, method 590 comprises allowing the user to access only documents from the search result mapped to document repositories of the plurality of document repositories for which access to the user is authorized.

In some embodiments, method 590 includes creating the plurality of security groups and adding users to each of the plurality of security groups. In some embodiments, allowing the user to access only the documents from the search result mapped to the document repositories of the plurality of document repositories for which access to the user is authorized includes authenticating the user by creating a token for verification. In certain embodiments, providing the index includes flagging at least some of the plurality of documents as restricted. In certain embodiments, method 590 includes providing access to the documents flagged as restricted and which are referenced in the search result only to users specifically identified in a whitelist as having access to the documents flagged as restricted. In certain embodiments, providing the index includes applying a litigation tag to at least some of the plurality of documents such that the tagged documents are prohibited from being referenced in the search result.

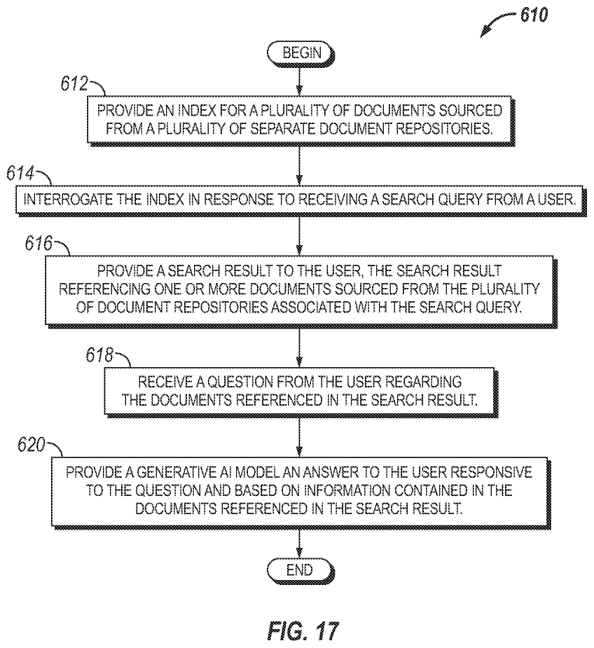

Referring now to FIG. 17, a flowchart of a computer implemented method 590 for providing access to documents across a plurality of separate document repositories is shown according to some embodiments. Initially, method 610 begins at block 612 by providing an index for a plurality of documents sourced from a plurality of separate document repositories. At block 614, method 610 includes interrogating the index in response to receiving a search query from a user.

At block 616, method 610 includes providing a search result to the user, the search result referencing one or more documents sourced from the plurality of document repositories associated with the search query. At block 618, method 610 includes receiving a question from the user regarding the documents referenced in the search result. At block 620, method 610 includes providing by a generative AI model an answer to the user responsive to the question and based on information contained in the documents referenced in the search result.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer implemented method for providing access to documents across a plurality of separate document repositories; the method comprising:
(a) providing an index containing a plurality of documents sourced from a plurality of separate document repositories;
(b) extracting content from a new document in response to uploading of a new document to one of the plurality of document repositories;
(c) automatically detecting a presence of sensitive information in the extracted content of the new document; and
(d) updating the index to flag the presence of sensitive information in the content of the new document following (c).

2. The method of claim 1, further comprising:
(e) deleting the new document containing the sensitive information from the document repository containing the new document.

3. The method of claim 1, further comprising:
(e) allowing a user to select and download a one or more documents referenced by the search result.

4. The method of claim 1, further comprising:
(e) automatically providing the sensitive information to an approver for review.

5. The method of claim 4, further comprising:
(f) deleting the new document in response to receiving a deletion approval from an approver following (e).

6. The method of claim 1, wherein the sensitive information comprises at least one of personally identifiable information (PII) and profanity.

7. The method of claim 1, further comprising:
(e) sorting by a generative artificial intelligence (AI) model the plurality of documents into separate topics.

8. The method of claim 1, further comprising:
(e) interrogating the index in response to receiving a search query from a user;
(f) providing a search result to the user, the search result referencing one or more documents of the plurality of documents sourced from the plurality of document repositories associated with the search query;
(g) receiving a question from the user regarding the documents referenced in the search result; and
(h) providing by a generative artificial intelligence (AI) model an answer to the user responsive to the question and based on information contained in the documents referenced in the search result.

9. A computer implemented method for providing access to documents across a plurality of separate document repositories; the method comprising:
(a) extracting content from a plurality of documents stored in one or more storage containers and sourced from a plurality of separate document repositories;
(b) providing an index containing the extracted content of the plurality of documents sourced from a plurality of separate document repositories; and
(c) sorting by a generative artificial intelligence (AI) model the plurality of documents into separate subject matter topics.

10. The method of claim 9, further comprising:
(d) interrogating the index in response to receiving a search query from a user; and
(e) providing a search result to the user, the search result referencing one or more documents sourced from the plurality of document repositories associated with the search query and wherein the one or more documents are sorted by their respective subject matter topics.

11. The method of claim 9, further comprising:
(d) receiving a question from a user regarding the documents referenced in a search result; and
(e) providing by the generative AI model an answer to the user responsive to the question and based on information contained in the documents referenced in the search result.

12. The method of claim 9, wherein the generative AI model comprises a large language model (LLM).

13. The method of claim 9, further comprising:
(d) extracting content from a new document in response to uploading of a new document to one of the plurality of document repositories; and
(e) automatically detecting for the presence of sensitive information in the extracted content of the new document.

14. The method of claim 13, further comprising:
(f) deleting the new document containing the sensitive information from the document repository containing the new document.

15. A computer implemented method for providing access to documents across a plurality of separate document repositories: the method comprising:
(a) extracting content from a plurality of documents sourced from a plurality of separate document repositories;
(b) providing an index containing the extracted content of the plurality of documents sourced from a plurality of separate document repositories;
(c) interrogating the index in response to receiving a search query from a user;
(d) providing a search result to the user, the search result referencing one or more documents sourced from the plurality of document repositories associated with the search query;
(e) receiving one or more prompts from the user regarding the documents referenced in the search result; and
(f) providing by a generative artificial intelligence (AI) model a response to the user responsive to the one or more prompts and based on information contained in the documents referenced in the search result.

16. The method of claim 15, further comprising:
(g) extracting by the generative AI model content from the plurality of documents sourced from the plurality of document repositories to construct a data visualization based on the one or more prompts.

17. The method of claim 16, wherein the data visualization comprises a knowledge tree.

18. The method of claim 15, wherein (e) comprises extracting by the generative AI model tabular or graphical data contained in the documents referenced in the search result.

19. The method of claim 15, wherein (e) comprises extracting by the generative AI model metadata from the documents referenced in the search result.

20. The method of claim 15, further comprising:
(g) extracting content from a new document in response to uploading of a new document to one of the plurality of document repositories; and
(h) automatically detecting a presence of sensitive information in the extracted content of the new document.
